(19) United States
(12) Patent Application Publication
(10) Pub. No.: US 2018/0212290 A1
(43) Pub. Date: Jul. 26, 2018

(54) STORAGE BATTERY SYSTEM

(71) Applicant: DENSO CORPORATION, Kariya-city, Aichi-pref. (JP)

(72) Inventors: Yuta SAIGA, Kariya-city (JP); Shinya KASAMATSU, Kariya-city (JP); Takuya FUSE, Kariya-city (JP); Touru KAWAGUCHI, Kariya-city (JP)

(21) Appl. No.: 15/744,128

(22) PCT Filed: Jun. 8, 2016
(86) PCT No.: PCT/JP2016/002775

§ 371 Date: Jan. 12, 2018

(30) Foreign Application Priority Data
Aug. 7, 2015 (JP) 2015-157042

(51) Int. Cl. H01M 10/659; H01M 10/613; H01M 10/615; H01M 10/625; H01M 10/627; H01M 10/647; H01M 10/6556; H01M 10/6565; H01M 10/6568

(52) U.S. Cl. CPC H01M 10/659; H01M 10/613; H01M 10/615; H01M 10/625; H01M 2220/20; H01M 10/647; H01M 10/6556; H01M 10/6565; H01M 10/6568; H01M 10/627

(57) ABSTRACT

A storage battery system includes a rechargeable storage battery and a solid heat storage portion. The solid heat storage portion is made of a heat storage material that reversibly undergoes a phase transition with absorption and release of a latent heat between a solid phase and a solid phase at a certain phase transition temperature. The heat storage material causes a solid phase to solid phase state phase transition when a temperature of the storage battery reaches the phase transition temperature to maintain the temperature of the storage battery at the phase transition temperature.

### CROSS REFERENCE TO RELATED APPLICATION

This application is based on Japanese Patent Application No. 2015-157042 filed on Aug. 7, 2015, the disclosure of which is incorporated herein by reference.

### TECHNICAL FIELD

The present disclosure relates to a storage battery system including a chargeable and dischargeable storage battery.

### BACKGROUND ART

A heat storage sheet containing coated particles, in which a latent heat storage material is enclosed, has been proposed in, for example, Patent Literature 1. The heat storage sheet maintains a temperature of a target object with the utilization of a property of absorbing or releasing a heat when the latent heat storage material causes a state-to-state phase transition from a liquid phase to a solid phase or from the solid phase to the liquid phase. The coated particles function as capsule-like containers for maintaining a shape of the latent heat storage material that has been changed into a liquid phase.

### PRIOR TECHNICAL LITERATURE

### Patent Literature

PATENT LITERATURE 1: JP-A-2009-140786

However, in the conventional technique described above, since a container is required to maintain the shape of the latent heat storage material when the latent heat storage material has transitioned from the solid phase to the liquid phase, the container causes a heat resistance when the heat is put into and out of the coated particles.

In this example, it is known that the storage battery is deteriorated in electrolytic solution due to a heat generation caused by charging and discharging, a temperature rise caused by solar heat, and the like, thereby shortening a service life. For that reason, it is conceivable to reduce the rise in the temperature of the storage battery with the use of the heat storage sheet described above. However, there is a risk that a heat retention effect of the heat storage sheet cannot be sufficiently obtained due to a loss caused by a heat resistance.

### SUMMARY OF INVENTION

It is an object of the present disclosure to produce a storage battery system.

According to one aspect of the present disclosure, a storage battery system comprises a rechargeable storage battery. The storage battery system further comprises a solid heat storage portion that is made of a heat storage material capable of reversibly undergoing a phase transition with absorption and release of a latent heat between a solid phase and a solid phase at a certain phase transition temperature, and causing a solid phase to solid phase state phase transition when a temperature of the storage battery reaches the phase transition temperature to maintain the temperature of the storage battery at the phase transition temperature.

According to the above configuration, since the solid state is maintained even when a solid heat storage portion generates a phase transition, a container for maintaining the shape of the solid heat storage portion is unnecessary. Therefore, the heat resistance of the outer wall of the container or the like when the solid heat storage portion absorbs the latent heat from the storage battery can be reduced.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a configuration diagram of a storage battery system according to a first embodiment of the present disclosure,

FIG. 2 is a diagram illustrating the amount of inflow heat from an outside to the storage battery system,

FIG. 3 is a diagram illustrating a temperature change of the storage battery by a fixed heat storage portion,

FIG. 4 is a diagram illustrating a temperature change of the storage battery in a case where a maximum temperature of the storage battery is 35° C. and a volume of a solid heat storage portion is 0.4 L,

FIG. 5 is a diagram illustrating a temperature change of the storage battery in a case where the maximum temperature of the storage battery is 35° C. and the volume of the solid heat storage portion is 1.5 L,

FIG. 6 is a diagram illustrating a temperature change of the storage battery in a case where the maximum temperature of the storage battery is 40° C. and the volume of the solid heat storage portion is 1.5 L,

FIG. 7 is a diagram illustrating a temperature change of the storage battery in a case where the maximum temperature of the storage battery is 40° C. and the volume of the solid heat storage portion is 3.0 L,

FIG. 8 is a configuration diagram of a storage battery system according to a second embodiment of the present disclosure, and

FIG. 9 is a configuration diagram of a storage battery system according to a third embodiment of the present disclosure.

### DESCRIPTION OF EMBODIMENTS

Hereinafter, embodiments of the present disclosure will be described based on the drawings.

### First Embodiment

Hereinafter, a first embodiment of the present disclosure will be described with reference to the drawings. A storage battery system according to the present embodiment is a driving source mounted on an electric vehicle such as a hybrid vehicle. Further, the storage battery system is also used as a power source for driving a load such as a motor generator, a power supply for an electronic device, and the like.

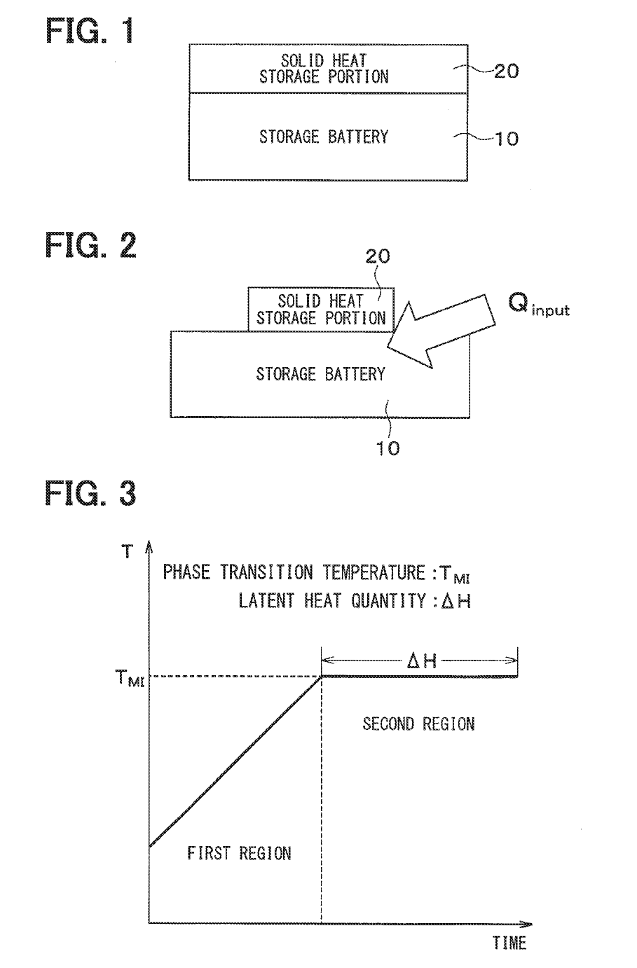

As shown in FIG. 1, the storage battery system includes a storage battery 10 and a solid heat storage portion 20. The storage battery 10 is a rechargeable secondary battery. The storage battery 10 is mounted on a vehicle.

More specifically, the storage battery 10 includes multiple battery cells such as a lithium ion battery and a case that houses the battery cells. An outer shape of the case is, for example, a rectangular parallelepiped. The case is made of a metal material, a resin material, or the like. The multiple battery cells are connected in series with each other to form one battery. Each of the battery cells are a plate-shaped, block-shaped battery cell, or the like.

The solid heat storage portion 20 has a function of maintaining a constant temperature of the storage battery 10 when the temperature of the storage battery 10 reaches the phase transition temperature. The solid heat storage portion 20 is made of a heat storage material which undergoes a phase transition reversibly with absorption and release of a latent heat between a solid phase and a solid phase at a certain phase transition temperature. In other words, the solid heat storage portion 20 causes a solid phase to solid phase state phase transition while maintaining a solid state.

The solid heat storage portion 20 is formed in a plate shape. The solid heat storage portion 20 comes in direct contact with the storage battery 10. According to such a configuration, since the latent heat can be exchanged directly between the solid heat storage portion 20 and the storage battery 10, the heat retention effect of the storage battery 10 by the solid heat storage portion 20 can be sufficiently obtained.

In the present embodiment, the solid heat storage portion 20 is configured to have the same size as that of one side surface of the storage battery 10. In other words, the solid heat storage portion 20 comes in contact with the entire side surface of the storage battery 10. As a method of bringing the solid thermal storage unit 20 and the storage battery 10 into direct contact with each other, there are a method using grease, a method using a case where the solid heat storage portion 20 and the storage battery 10 are pressed against each other, and the like.

The heat storage material contains vanadium. For example, vanadium dioxide (VO2) is employed as the heat storage material. The phase transition temperature of the solid heat storage portion 20 is set to a desired temperature by adding additives to vanadium dioxide. The phase transition temperature is set at 30° C., for example.

Next, a thermal equilibrium model of the storage battery 10 and the solid heat storage portion 20 will be described. As shown in FIG. 2, a temperature of the storage battery 10 rises due to the amount of inflow heat (Qinput) from an outside such as a heat of the vehicle or a solar heat. In FIG. 2, the solid heat storage portion 20 is drawn in a size smaller than one side surface of the storage battery 10 in order to illustrate the amount of inflow heat.

When it is assumed that a total heat capacity of the storage battery system is C, a total weight of the storage battery system is m, a temperature rise of the storage battery system is ΔT, a weight of the solid heat storage portion 20 is mVO2, and the latent heat quantity is ΔH, the thermal equilibrium model of the storage battery system is represented by the following Equation 1.

∫Qinputdt=Cm(ΔT)+ΔH (Equation 1)

Also, when it is assumed that the latent heat quantity per kg is Δh, the latent heat quantity ΔH is expressed by the following Equation 2.

ΔH=mVO2(Δh) (Equation 2)

Equation 1 shows that the amount of inflow heat Qinput of integration up to a certain time is consumed with the temperature rise ΔT and the latent heat ΔH in the solid phase to solid phase state phase transition of the solid heat storage portion 20. In other words, the temperature rise ΔT of the storage battery system is consumed by the latent heat ΔH, to thereby keep the constant temperature of the storage battery system.

More specifically, as shown in FIG. 3, in a first region before the temperature of the storage battery system reaches a phase transition temperature (TMI), the amount of inflow heat into the storage battery 10 is all used to raise the temperature of the storage battery system. Therefore, the temperature of the storage battery 10 continues to rise.

In a subsequent second region, when the temperature of the storage battery 10 reaches the phase transition temperature, a solid phase to solid phase state phase transition based on the latent heat occurs between the storage battery 10 and the solid heat storage portion 20. In other words, the solid heat storage portion 20 absorbs the latent heat from the storage battery 10. As a result, the temperature of the storage battery 10 is maintained at the phase transition temperature until ΔH=∫Qinputdt is achieved.

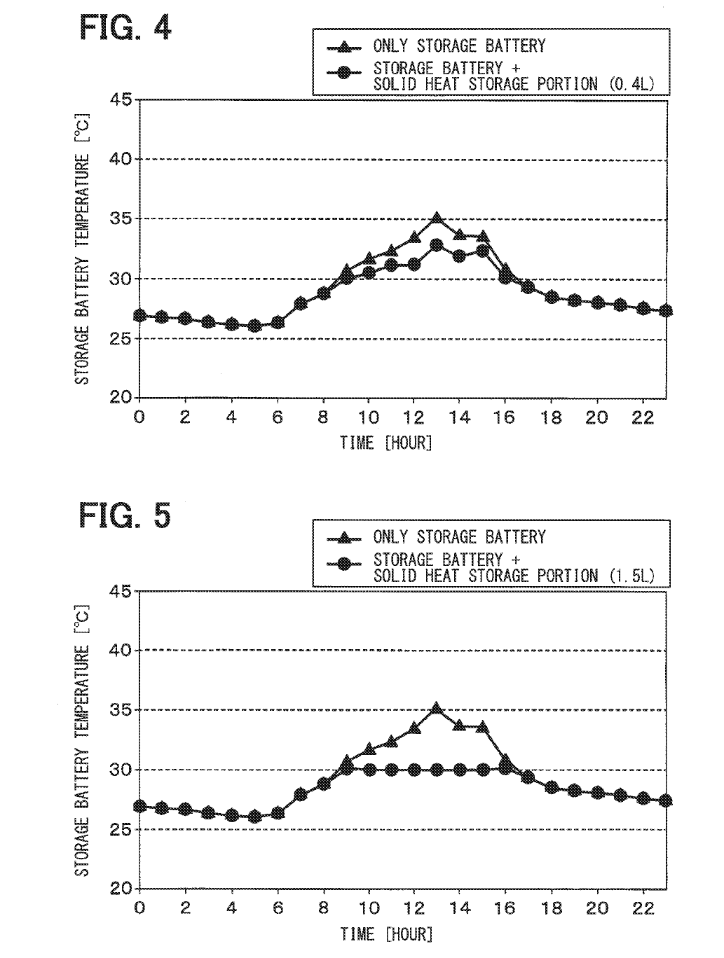

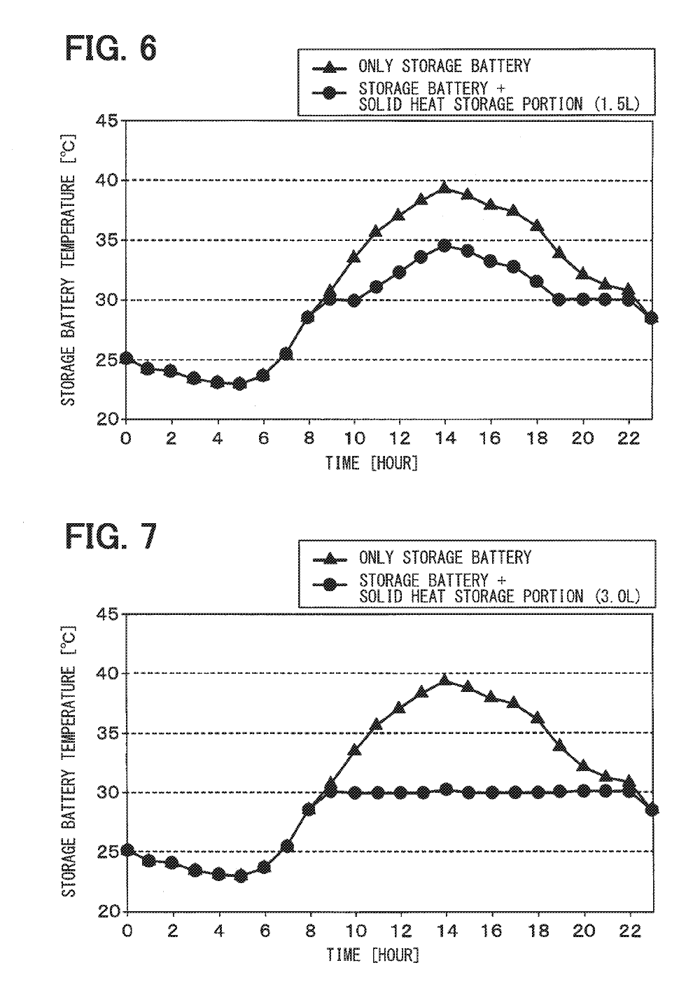

The present inventors have examined the temperature change in the storage battery 10 in the case of only the storage battery 10 and the case of mounting the solid heat storage portion 20. The results are shown in FIGS. 4 to 7. FIGS. 4 to 7 show the temperature change of the storage battery 10 with time. In addition, FIGS. 4 and 5 show a case in which a maximum temperature of the storage battery 10 reaches 35° C., and FIGS. 6 and 7 show a case in which the maximum temperature of the storage battery 10 reaches 40° C.

First, in the case of only the storage battery 10, the temperature of the storage battery 10 rises from around 6 o'clock, reaches the maximum temperature around 13 o'clock to 14 o'clock, and descends after 14 o'clock. In the configuration in which the solid heat storage portion 20 is provided in the storage battery 10, it is understood that the temperature rise of the storage battery 10 is reduced from 8 o'clock onward.

Specifically, as shown in FIG. 4, when the solid heat storage portion 20 is 0.4 L, the temperature of the storage battery 10 exceeds the phase transition temperature, but the temperature is reduced as compared with the case of only the storage battery 10. On the other hand, as shown in FIG. 5, when the solid heat storage portion 20 is 1.5 L, the temperature of the storage battery 10 is maintained at the phase transition temperature without exceeding the phase transition temperature.

Likewise, as shown in FIG. 6, when the solid heat storage portion 20 is 1.5 L, the temperature of the storage battery 10 exceeds the phase transition temperature, but the temperature is reduced as compared with the case of only the storage battery 10. On the other hand, as shown in FIG. 7, when the solid heat storage portion 20 is 3.0 L, the temperature of the storage battery 10 is maintained at the phase transition temperature without exceeding the phase transition temperature.

In this way, the maximum temperature of the storage battery 10 is reduced with the configuration including not only the storage battery 10 but also the solid heat storage portion 20. Furthermore, since the volume of the solid heat storage portion 20 is increased to increase the amount of latent heat absorbed by the solid heat storage portion 20 from the storage battery 10, the heat retention effect of the storage battery 10 is improved.

As described above, in the present embodiment, the solid heat storage portion 20 that causes the solid phase to solid phase state phase transition is mounted on the storage battery 10. As a result, since the solid heat storage portion 20 undergoes the phase transition while maintaining the solid state, a container for maintaining the shape of the solid heat storage portion 20 can be made unnecessary. For that reason, the heat resistance of an outer wall of the container or the like when the latent heat is exchanged between the storage battery 10 and the solid heat storage portion 20 can be reduced.

In particular, an electrolytic solution can be prevented from deteriorating in the storage battery 10 to shorten the service life due to the heat generation caused by charging and discharging the storage battery 10, the temperature rise in summer caused by the solar heat, and the like. In other words, the change in the temperature of the storage battery 10 can be alleviated without the use of a heat retention device such as a heater or a cooling device, thereby being capable of lengthening the life of the storage battery 10.

Further, in a vehicle equipped with an independent storage battery 10 such as a hybrid vehicle, since the heat retention device does not operate when the engine is stopped, the temperature change of the storage battery 10 cannot be coped with. However, the solid heat storage portion 20 according to the present embodiment can obtain a high effect without the use the heat retention device even when the engine is stopped.

### Second Embodiment

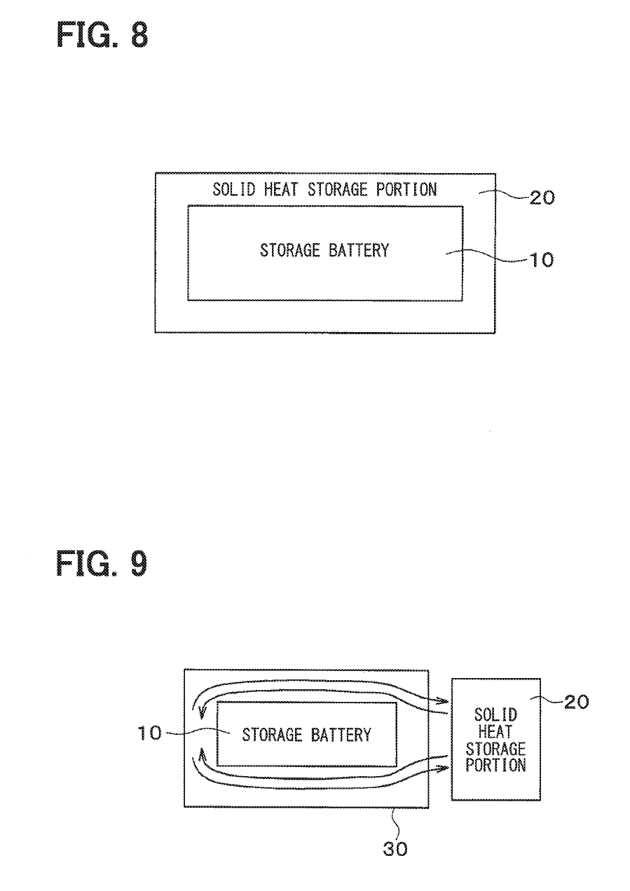

In the present embodiment, components different from those in the first embodiment will be described. As shown in FIG. 8, a solid heat storage portion 20 surrounds a storage battery 10. Specifically, the solid heat storage portion 20 is configured in a tubular shape and surrounds entire four side surfaces of the case of the storage battery 10. In other words, both end faces of the case of the storage battery 10 are exposed from the solid heat storage portion 20.

According to the above configuration, since the solid heat storage portion 20 can absorb a latent heat from multiple directions of the storage battery 10, the heat retention effect of the storage battery 10 by the solid heat storage portion 20 can be sufficiently obtained.

### Third Embodiment

In the present embodiment, components different from those in the first embodiment and the second embodiment will be described. As shown in FIG. 9, a storage battery system includes a storage battery 10, a solid heat storage portion 20, and a flow channel portion 30.

The flow channel portion 30 configures a flow channel for performing a heat exchange between the storage battery 10 and the solid heat storage portion 20 through a heat medium while circulating the heat medium between the storage battery 10 and the solid heat storage portion 20. The heat medium flows in a space between the storage battery 10 and an inner wall surface of the flow channel portion 30.

In other words, in the present embodiment, the storage battery 10 and the solid heat storage portion 20 are arranged apart from each other. The heat medium is, for example, gas or water. As described above, since the solid heat storage portion 20 is a solid, there is an advantage that it is easy to deal with a liquid such as water. Further, since the storage battery 10 and the solid heat storage portion 20 can be disposed separately, there is an advantage that a space of the vehicle can be effectively utilized.

### OTHER EMBODIMENTS

The configuration of the storage battery system shown in each of the embodiments described above is merely an example, and the present disclosure is not limited to the configurations described above, and other configurations that can implement the present disclosure can also be employed. For example, the storage battery 10 is not limited to being mounted on a vehicle, and the storage battery 10 may be configured for stationary use. It is needless to say that the external shape of the storage battery 10 is not limited to the rectangular parallelepiped as described above, and other external shapes may be employed in some cases.

In the second embodiment, the solid heat storage portion 20 is configured in a tubular shape surrounding the storage battery 10, but may surround the entire storage battery 10. Incidentally, a connector or the like for taking out a power supply from the storage battery 10 is exposed from the solid heat storage portion 20.

The present disclosure is described based on the embodiments, and it is understood that this disclosure is not limited to the embodiments or the structure. The present disclosure includes various modification examples and modifications within the same range. In addition, it should be understood that various combinations or aspects, or other combinations or aspects, in which only one element, one or more elements, or one or less elements is included to the various combinations or aspects, are included in the scope or the technical idea of the present disclosure.

1. A storage battery system comprising:
a rechargeable storage battery; and
a solid heat storage portion that is made of a heat storage material capable of reversibly undergoing a phase transition with absorption and release of a latent heat between a solid phase and a solid phase at a certain phase transition temperature, and causing a solid phase to solid phase state phase transition when a temperature of the storage battery reaches the phase transition temperature to maintain the temperature of the storage battery at the phase transition temperature.

2. The storage battery system according to claim 1, wherein the solid heat storage portion is in direct contact with the storage battery).

3. The storage battery system according to claim 1, wherein the solid heat storage portion surrounds the storage battery.

4. The storage battery system according to claim 1, further comprising:
a flow channel portion that causes a heat medium to circulate between the storage battery and the solid heat storage portion to exchange a heat between the storage battery and the solid heat storage portion through the heat medium.

5. The storage battery system according to claim 1, wherein the heat storage material includes vanadium.

6. The storage battery system according to claim 1, wherein the storage battery is mounted on a vehicle.

7. The storage battery system according to claim 1, wherein
the storage battery is configured in a shape having a side surface, and
the solid heat storage portion is configured in a tubular shape and surrounds the side surface of the storage battery.
